(19) United States
(12) Patent Application Publication
(10) Pub. No.: US 2026/0186741 A1
(43) Pub. Date: Jul. 2, 2026

(54) RECONFIGURABLE MIXED-PRECISION PROCESSING APPARATUS AND OPERATING MEHTOD THEREOF

(71) Applicant: AIPS Ltd., Suwon-si (KR)

(72) Inventors: Young Min CHO, Suwon-si (KR); Yoon Tae LEE, Bucheon-si (KR)

(21) Appl. No.: 19/003,443

(22) Filed: Dec. 27, 2024

(30) Foreign Application Priority Data
Dec. 26, 2024 (KR) 10-2024-0197449

(51) Int. Cl. G06F 7/499; G06F 7/523

(52) U.S. Cl. CPC G06F 7/49915; G06F 7/523

(57) ABSTRACT

An operating method of a reconfigurable mixed-precision processing apparatus, includes performing a multiplication on a plurality of operands to calculate a first result value in a floating-point format, performing preprocessing on the first result value to calculate a second result value, performing an addition on a mantissa value of the second result value to calculate a third result value, and converting a mantissa of the third result value into a mantissa in a floating-point format to calculate a fourth result value, in which the operand includes any one of a floating-point format, an integer format, and 1 bit.

### CROSS-REFERENCE TO RELATED APPLICATIONS

This application claims the priority of Korean Patent Application No. 2024-0197449 filed on Dec. 26, 2024 in the Korean Intellectual Property Office, the disclosure of which is incorporated herein by reference.

### BACKGROUND

### Field

The present invention relates to a reconfigurable mixed-precision processing apparatus and an operating method thereof, and more specifically, to an apparatus for accelerating quantized neural network operations with a combination of various precisions and an operating method thereof.

### Description of the Related Art

Recently, as the scale of AI models has rapidly increased, inference methods that effectively handle context and sequence length have become important in various tasks such as translation, conversational chat, and code analysis. AI models for processing these tasks must store and utilize various information, which has resulted in a significant increase in the amount of weight (FFN) and key-value (MHA) cache and computational amount.

To solve this problem, conventionally, quantization methods that convert floating point-based representation methods into integers with fewer bits have been mainly used.

Since the quantization inherently entails a decrease in model performance, a mixed-precision quantization method is generally used, which quantizes data such as activation values that are sensitive to quantization with high precision while having a small memory size, and quantizes data such as weights and key-values that are insensitive to quantization and occupy a large memory with low precision.

However, the conventional mixed-precision quantization method is configured to support only fixed-precision operations in existing accelerator systems, including the IEEE method. This not only causes additional computational overhead such as dequantization and constraints on the throughput per area, but also includes unnecessary normalization and rounding operations in the middle, which causes unnecessary degradation of the overall model performance.

To address this, it is necessary to develop new technologies that can directly support various mixed-precision combination operations, thereby improving throughput and model accuracy.

### SUMMARY

The present invention is intended to solve the above problems, and an object of the present invention is to provide an operation device capable of performing various mixed-precision combination operations and an operating method thereof.

The technical problems of the present invention are not limited to the technical problems mentioned above, and other technical problems not mentioned will be clearly understood by those skilled in the art from the description below.

An operating method of a reconfigurable mixed-precision processing apparatus according to one embodiment of the present invention, includes: performing a multiplication on a plurality of operands to calculate a first result value in a floating-point format; performing preprocessing on the first result value to calculate a second result value; performing an addition on a mantissa value of the second result value to calculate a third result value; and converting a mantissa of the third result value into a mantissa in a floating-point format to calculate a fourth result value, in which the operand includes any one of a floating-point format, an integer format, and 1 bit.

The calculating of the first result value may include, in a case of multiplication of data of the floating-point format-floating-point data and data of the integer format integer data, calculating a sign using an XOR gate for a sign of the floating-point data and a sign of the integer data, calculating a multiplication value by multiplying the mantissa value of the floating-point data and an integer value of the integer data, performing a shift according to a preset criterion from a least significant bit of the multiplication value, increasing an exponent value of the floating-point data by the number of times the shift is performed, and performing rounding in a preset method based on the shift result to calculate the first result value.

The calculating of the first result value may include, in the case of multiplication of first integer data and second integer data, calculating a sign using an XOR gate for a sign of the first integer data and a sign of the second integer data, calculating a multiplication value by multiplying an integer value of the first integer data and an integer value of the second integer data, calculating an absolute value of the multiplication value, calculating the number of leading ‘0’s in binary representation of the calculated absolute value, calculating an exponent according to a preset expression based on the number of ‘0’s and a bias, calculating an upper N bit of the multiplication value as a mantissa, and calculating the first result value using the sign, the exponent, and the mantissa. The N is natural number.

The calculating of the second result value may include checking whether the data is integer data that has passed through a multiplication unit by using a 1-bit weight and integer activation, dividing, when the data is not the integer data, a plurality of floating-point data into a sign section, an exponent section, and a mantissa section, and searching for data having a maximum value among the plurality of exponent sections, obtaining a difference between a maximum exponent value of the searched data and exponent values of the other data and shifting the mantissa value of the floating-point data by the difference, determining whether a sign value of the floating-point data is negative, and performing a 2's complement operation on the shifted data when the sign value is negative.

the calculating of the first result value includes, in a case of multiplication of first floating-point data and second floating-point data, calculating a sign using an XOR gate for a sign of the first floating-point data and a sign of the second floating-point data, calculating a multiplication value by multiplying an mantissa value of the first floating-point data and an mantissa value of the second floating-point data, calculating a addition value by adding an exponent value of the first floating-point data and an exponent value of the second floating-point data, calculating a first normalization value by normalizing the addition value to be less than or equal to a preset value, calculating a second normalization value by normalizing the multiplication value to be less than or equal to a preset value, calculating the first result value through performing rounding for the calculated sign, the first normalization value, the second normalization value.

A reconfigurable mixed-precision processing apparatus according to another embodiment, includes: a multiplication unit configured to perform a multiplication on a plurality of operands to calculate a first result value in a floating-point format; a preprocessing unit configured to perform preprocessing on the first result value to calculate a second result value; an adder tree configured to perform an addition on a mantissa value of the second result value to calculate a third result value; and a normalization unit and a rounding unit configured to convert a mantissa of the third result value into a mantissa in a floating-point format to calculate a fourth result value, in which the operand includes any one of a floating-point format, an integer format, and 1 bit.

According to the reconfigurable mixed-precision processing apparatus and the operating method thereof according to one embodiment of the present invention, in order to maintain the robustness of a model during a quantization process, damage to the model can be minimized by using various floating-point and integer types for each layer and each element in a single model according to quantization sensitivity, and in order to perform this mixed-precision operation, the operation can be flexibly processed within a single hardware without arranging separate hardware operation units for each precision or performing a dequantization process that converts it to a unified precision, so that the overhead for the entire operation can be reduced.

In addition, according to the reconfigurable mixed-precision processing apparatus and the operating method thereof according to one embodiment of the present invention, the mixed-precision operations can be processed with minimal overhead by reconfiguring the operation order based on a sparse format such as CSR and Difference Encoding for high-precision outlier data that has a significant impact on the quantization resistance of a model.

In addition, according to the reconfigurable mixed-precision processing apparatus and the operating method thereof according to one embodiment of the present invention, low-precision quantization can increase the overall throughput depending on the degree of quantization through the reconfigurable mixed-precision matrix operation apparatus rather than simply reducing memory.

In addition, according to the reconfigurable mixed-precision processing apparatus and the operating method thereof according to one embodiment of the present invention, unlike the existing IEEE format, the integration density per area can be improved by reducing intermediate normalization and rounding processes, and the precision loss occurring in the intermediate normalization and rounding processes can be reduced.

In order to more fully understand the drawings cited in the detailed description of the present invention, a brief description of each drawing is provided.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram schematically illustrating a reconfigurable mixed-precision processing system according to one embodiment of the present invention;

FIG. 2A is a block diagram illustrating the configuration of a processor according to one embodiment of the present invention;

FIG. 2B is a flowchart illustrating an operating method of the processor according to one embodiment of the present invention;

FIGS. 3A to 3D are conceptual diagrams illustrating the operation of the processor according to one embodiment of the present invention;

FIG. 4 is a block diagram illustrating the configuration of a multiplier according to one embodiment of the present invention;

FIGS. 5A to 5C are conceptual diagrams illustrating the operation of the multiplier according to one embodiment of the present invention;

FIG. 6 is a flowchart illustrating the operating method of the processor according to one embodiment of the present invention;

FIG. 7 is a conceptual diagram illustrating the operation of the processor according to one embodiment of the present invention;

FIG. 8 is a block diagram schematically illustrating the reconfigurable mixed-precision processing system according to one embodiment of the present invention;

FIG. 9A and FIG. 9B are flowcharts illustrating the operating method of the reconfigurable mixed-precision processing system according to one embodiment of the present invention; and

FIG. 10 is a block diagram schematically illustrating the reconfigurable mixed-precision processing system according to one embodiment of the present invention.

### DETAILED DESCRIPTION OF THE EMBODIMENT

Hereinafter, various embodiments of the present invention will be described with reference to the attached drawings. It should be understood that the present invention is not limited to specific embodiments, but includes various modifications, equivalents, and/or alternatives of the embodiments of the present invention. In connection with the description of the drawings, similar reference numerals may be used for similar components.

In the present document, the expressions “have”, “may have”, “include”, or “may include” indicate the presence of a feature (for example, a numerical value, function, operation, or component such as a part), but do not exclude the presence of additional features.

In the present document, the expressions “A or B”, “at least one of A and/or B”, or “one or more of A or/and B” may include all possible combinations of the items listed together. For example, “A or B”, “at least one of A and B”, or “at least one of A or B” may all refer to cases where (1) at least one A is included, (2) at least one B is included, or (3) both at least one A and at least one B are included.

Various expressions “first,” or “second” used in the present document may describe various components, regardless of order and/or importance, and are only used to distinguish one component from another, but do not limit the components. For example, without departing from the scope of the rights set forth in the present document, a first component may be named a second component, and similarly, the second component may also be renamed as the first component.

The expression “configured (or set) to” used herein may be used interchangeably with, for example, “suitable for”, “having the capacity to”, “designed to”, “adapted to”, “made to”, or “capable of”, depending on the situation. The term “configured (or set) to” does not necessarily mean “specifically designed to”.

In the present document, terms such as “command”, “instruction”, “control information”, “message”, “information”, “data”, “packet”, “data packet”, “intent” and/or “signal” transmitted and received between the first electronic device(s) and the second electronic device(s) may include or refer to human-perceivable ideas or specific electrical representations (for example, digital sign/analog physical quantities) regardless of their expressions. It will be apparent to those skilled in the art to which the invention disclosed in the present disclosure pertains that the exemplary expressions listed above may be interpreted in various ways depending on the context in which they are used. In the present document, “A is greater than B” not only simply means “A is greater than B” but also includes “A is equal to or greater than B”.

The terms used in the present document are used only to describe specific embodiments and may not be intended to limit the scope of other embodiments. The singular expression may include the plural expression unless the context clearly indicates otherwise. The terms used herein, including technical or scientific terms, may have the same meaning as commonly understood by a person of ordinary skill in the art described in the present document. Among the terms used in the present document, terms defined in general dictionaries may be interpreted as having the same or similar meaning in the context of the related technology, and shall not be interpreted in an ideal or excessively formal meaning unless explicitly defined in the present document. In some cases, even when a term is defined in the present document, it cannot be interpreted to exclude the embodiments of the present document.

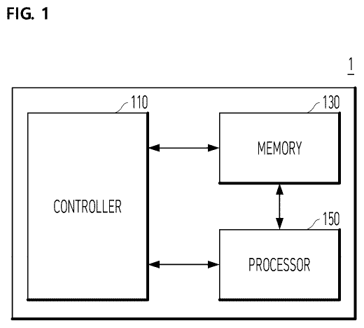

FIG. 1 is a block diagram schematically illustrating a reconfigurable mixed-precision processing system 1 according to one embodiment of the present invention.

The mixed-precision processing system 1 may include a controller 110, a memory 130, and a processor 150. In another embodiment, the system 1 may omit at least one of the above components or additionally include another component.

For reference, the components 110, 130 and 150 of the system 1 illustrated in FIG. 1 are merely exemplary components for explaining a reconfigurable mixed-precision processing method according to one embodiment of the present invention. That is, it is clear that the system 1 according to one embodiment of the present invention may additionally include other components in addition to the illustrated components.

The controller 110 is electrically connected to the memory 130 and the processor 150, and may execute operations or data processing related to control and/or communication of other components according to instructions, programs or software stored in the memory 130 during operation. Accordingly, execution of the instruction, application program or software may be understood as operation of the controller 110.

According to one embodiment of the present invention, the controller 110 may load data from the memory 130 and provide the data to the processor 150, and remove the processor 150 to perform computational processing on the data.

According to one embodiment of the present invention, the controller 110 may include a scheduler, an interface, a memory, a control circuit, or the like.

The memory 130 may be configured with various types of memory including high bandwidth memory (HBM), graphics double data rate (GDDR) memory, double data rate synchronous dynamic random access memory (DDR SDRAM), low power double data rate4(LPDDR4) SDRAM, low power DDR (LPDDR), Rambus dynamic random access memory (RDRAM), NAND flash memory, 3D NAND flash memory, NOR flash memory, resistive random access memory (RRAM), phase-change memory (PRAM), magneto-resistive random access memory (MRAM), ferroelectric random access memory (FRAM), spin transfer torque random access memory (STT-RAM), or the like.

According to one embodiment of the present invention, the memory 130 may include an interface, a high bandwidth memory (HBM), a graphics double data rate (GDDR) memory, a transpose unit, and a plurality of buffers. According to one embodiment of the present invention, the memory 130 may include various buffers or vector registers for data reuse, such as a buffer that individually stores the values of Q (query), V (value), and K (key) described below, and a bias buffer that stores a bias value.

The processor 150 may operate data provided from the memory 130 in a preset manner under the control of the controller 110.

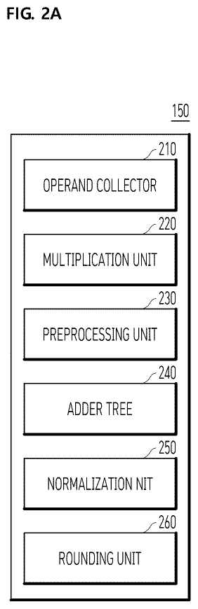

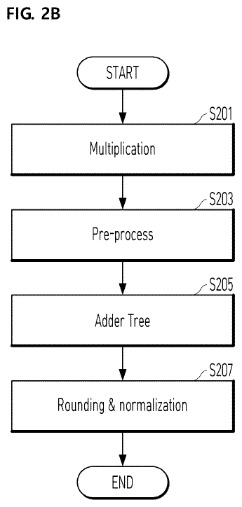

FIG. 2A is a block diagram illustrating the configuration of the processor 150 according to one embodiment of the present invention.

The processor 150 may include an operand collector 210, a multiplication unit 220, a preprocessing unit 230, an adder tree 240, a normalization unit 250, and a rounding unit 260. In other embodiments, the processor 150 may omit at least one of the above components or additionally include other components.

For reference, the components 210, 220, 230, 240, 250, and 260 of the processor 150 illustrated in FIG. 1 are merely exemplary components for explaining a reconfigurable mixed-precision processing method according to one embodiment of the present invention. That is, it is clear that the processor 150 according to one embodiment of the present invention may additionally include other components in addition to the illustrated components.

The operand collector 210 can collect and manage various operands required for an operation. According to one embodiment of the present invention, the operand collector 210 may collect and manage various operands required for a matrix operation from the memory 120, and may simultaneously collect various operands such as keys, values, and weights for complex operations such as matrix multiplication.

The operand collector 210 may be composed of a plurality of storage elements, each of which may store an element of a matrix or a submatrix.

According to one embodiment of the present invention, the operand collector 210 may provide the operand to the multiplication unit 220. However, when utilizing a quantization technique for 1-bit weight and integer activation (weight 1 activation 8; W1A8), the operand collector 210 may cause the operand to bypass through the multiplication unit 220 and the preprocessing unit 230 and directly provide the operand to the adder unit 240.

The multiplication unit 220 may perform multiplication by receiving at least one operand from the operand collector 210. According to one embodiment of the present invention, the multiplication unit 220 may perform vector-vector multiplication by having multiple multipliers arranged in parallel, and may perform vector-matrix multiplication as a whole by having these arranged in n lanes (n is a natural number), and may perform matrix-matrix multiplication in a streaming manner.

According to one embodiment of the present invention, the multiplication unit 220 may include a finite state machine (FSM) control structure to support reconfigurable mixed-precision operations.

For example, the multiplication unit 220 may support operations on a combination of a floating-point format and a floating-point format, operations on a combination of an integer format and an integer format, and operations on a combination of a floating-point format and an integer format.

The multiplication unit 220 may calculate the result value in floating-point format through various mixed-precision operations on the operands.

The preprocessing unit 230 may process data output from the multiplication unit 220 in the floating-point format. The preprocessing unit 230 may provide the processed data to the adder tree 240. According to one embodiment of the present invention, when integer data is input, the preprocessing unit 230 may bypass the data without a separate operation process.

The adder tree 240 may process addition of results of the operand collector 210, the multiplication unit 220, and the preprocessing unit 230. According to one embodiment of the present invention, the adder tree 240 may be configured as a parallel operation structure that performs an entire accumulation operation or continuous addition at once by grouping data items in pairs output from the operand collector 210, the multiplication unit 220, and the preprocessing unit 230.

The adder tree 240 of the present invention may perform addition on floating point mantissas or integer data. This supports completing matrix operations with only one rounding regardless of the number of data, since rounding is not performed for each adder, but only the final value of the adder tree 240 requires rounding.

The normalization unit 250 and the rounding unit 260 may convert an integer value in an integer format, on which the floating-point format (particularly, BF16) operation has been completed, into a mantissa in a floating-point format, and then output a value in the floating-point format (particularly, BF16) by combining a sign, an exponent, and a mantissa. Meanwhile, in the case of the integer format (particularly, INT8), the normalization unit 250, and the rounding unit 260 may output the value by fitting the increased number of bits to the floating-point format (particularly, BF16).

FIG. 2B is a flowchart illustrating the operating method of the processor 150 according to one embodiment of the present invention.

In Step S201, the processor 150 may perform a reconfigurable mixed-precision operation (multiplication) on the operands and calculate the result value in the floating-point format. The processor 150 may support the operations on the combination of the floating-point format and the floating-point format, the operations on the combination of the integer format and the integer format, and the operations on the combination of the floating-point format and the integer format.

In Step S203, the processor 150 may preprocess the result value in the floating-point format calculated in Step S201.

In Step S205, the processor 150 may continuously perform addition on the floating-point mantissas by using the adder tree 240.

In Step S207, the processor 150 may output the value in the floating-point format by using the normalization unit 250 and the rounding unit 260.

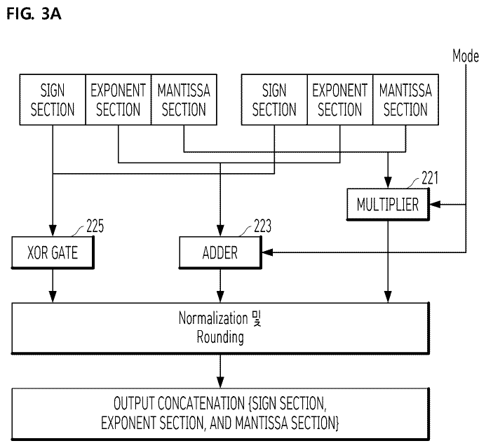

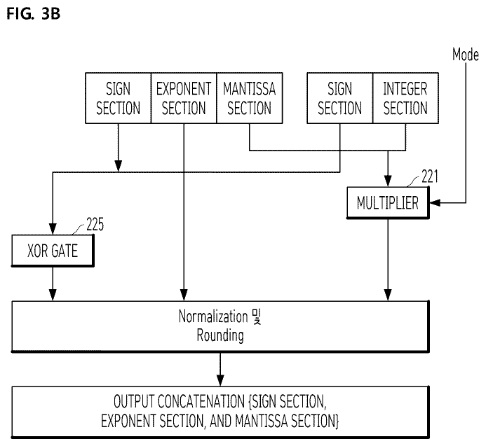

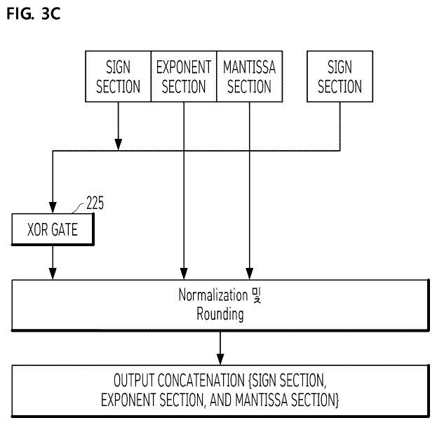

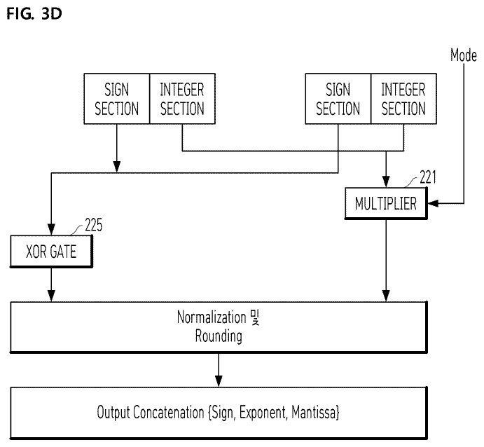

FIGS. 3A to 3D are conceptual diagrams illustrating the operation of the processor 150 according to one embodiment of the present invention. In particular, FIGS. 3A to 3D are conceptual diagrams illustrating the operation of a multiplication unit 220. The multiplication unit 220 may include a multiplier 221, an adder 223, and an XOR gate 225.

FIG. 3A illustrates the operation of the multiplication unit 220 for the floating-point format and the floating-point format. For convenience of explanation, it is assumed that the operation process is for BF16 and BF16.

BF 16 may include a 1-bit sign section, an 8-bit exponent section, and a 7-bit mantissa section.

The processor 150 may perform operations using XOR gates for each sign for different BF16. The processor 150 may perform addition on the values of the exponent sections of each different BF16 and multiplication on the values of the mantissa sections of each different BF16.

The processor 150 may normalize the result values of the exponent section and mantissa section. For example, the processor 150 may normalize the result value to be less than or equal to 2. The processor 150 may output a new BF16 by combining the sign calculated through rounding, the value for the exponent section, and the value for the mantissa section.

FIG. 3B illustrates the operation of the multiplication unit 220 for the floating-point format and the integer form. For convenience of explanation, it is assumed that the operation process is for BF16 and INT8.

INT 8 may include a 1-bit sign section and a 7-bit integer section.

The processor 150 may operate the sign section by using the XOR gate for the sign of BF16 and the sign of INT8. The processor 150 may perform normalization by using the exponent value of BF16 as it is. The processor 150 may multiply the value of the mantissa section of BF16 and the value of the integer section of INT8 by using the multiplier.

The processor 150 may normalize the result values of the exponent section and the mantissa section. According to one embodiment of the present invention, the processor 150 may perform a shift from the least significant bit (LSB) of a product value for the value of the mantissa section and the value of the integer section according to a preset criterion. For example, the processor 150 may perform a shift 7 times to the right from the LSB. The processor 150 may perform a shift from the position shifted 7 times to the ‘1’ value that appears last in the direction of the most significant bit. The processor 150 may increase the exponent value of BF16 by the number of shifts performed.

The processor 150 may perform rounding using the RNE (Round Nearest, ties to Even) method after cutting bits according to a preset criterion. For example, the processor 150 may cut 7 bits from the last ‘1’ value appearing in the most significant bit direction to the least significant bit direction and then perform rounding using the RNE method. The sign, the value for the exponent section, and the value for the mantissa section calculated through rounding may be combined to output a new BF16.

FIG. 3C illustrates the operation of the multiplication unit 220 for floating-point format and 1 bit.

The processor 150 may calculate the sign by using the XOR gate for the sign of BF16 and the sign of 1 bit. The processor 150 may perform the normalization by using the value of the exponent section and the value of the mantissa section for BF16 as they are. The processor 150 may output a new BF16 by combining the sign, the value for the exponent section, and the value for the mantissa section calculated through rounding.

FIG. 3D illustrates the operation of the multiplication unit 220 for the integer format and the integer format. For convenience of explanation, it is assumed that the operation process is for INT8 and INT8.

The processor 150 may operate the signs by using the XOR gate for signs of different INT8s. The operated sign may be used as the sign bit of the output BF16.

The processor 150 may multiply the values of integer sections of different INT8s using a multiplier.

The processor 150 may normalize each result value. Specifically, the processor 150 may calculate the absolute value of the multiplied value. The processor 150 may calculate the number of leading ‘0’s in the binary representation of the calculated absolute value. The processor 150 may calculate the exponent of BF16 according to a preset expression. For example, the processor 150 may calculate the exponent of BF16 by utilizing ‘27−(number of leading 0's)+(bias)’. The processor 150 may utilize the upper N bits as a mantissa and may round the upper 10 bits if necessary. The N is a natural number. Preferably, the processor 150 may utilize the upper 7 bits to 10 bits as a mantissa and may round the upper 10 bits if necessary.

The processor 150 may output a new BF16 by combining the calculated sign, the value for the exponent section, and the value for the mantissa section.

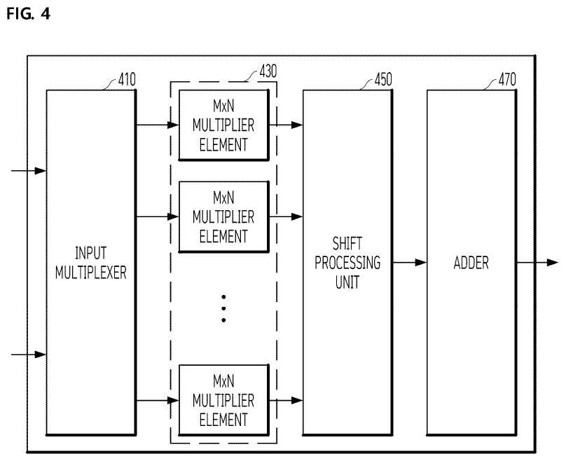

FIG. 4 is a block diagram illustrating the configuration of the multiplier 221 according to one embodiment of the present invention.

The multiplier 221 may include an input multiplexer 410, a plurality of multiplier elements (MEs) 430, a shift processing unit 450, and an adder 470.

The input multiplexer 410 may provide the plurality of operands provided from the operand collector 210 to the plurality of multiplier elements 430.

According to one embodiment of the present invention, when the provided operand is configured only in the floating-point format, the input multiplexer 410 may extract only the mantissa section of the floating-point type operand and provide the extracted mantissa section to the plurality of multiplier elements 430.

According to one embodiment of the present invention, when the provided operand is configured only in the integer format, the input multiplexer 410 may extract only the integer section of the integer operand and provide the extracted integer section to the plurality of multiplier elements 430.

According to one embodiment of the present invention, when the provided operand is configured in the floating-point format and the integer format, the input multiplexer 410 may extract the mantissa section of the floating-point format operand and the integer section of the integer format operand, respectively, and provide the extracted mantissa section and integer section to the plurality of multiplier elements 430.

The plurality of multiplier elements 430 may be configured of at least one M×N multiplier element. M and N are natural numbers. Preferably, M and N may be any one of 1, 2, 4, 8, and 16. The values of M and N may be set by the designer. The values of M and N may be changed according to the designer's setting. According to one embodiment of the present invention, the number of multiplier elements may be determined according to the values of M and N.

The plurality of multiplier elements 430 may individually perform multiplication according to the bits of the operands provided from the input multiplexer 410.

After performing the multiplication, each of the plurality of multiplier elements 430 may provide the result value (hereinafter, partial product) to the shift processing unit 450.

The shift processing unit 450 may shift each partial product provided by a bit corresponding to each partial product according to a certain standard.

The shift processing unit 450 may provide the shifted partial product to the adder 470.

The adder 470 may combine the above partial products. According to one embodiment of the present invention, the adder 470 may combine the partial products by using the Wallace tree structure. The adder 470 may output the combined final result. According to one embodiment of the present invention, the adder 470 may be reconfigured for each mixed precision case.

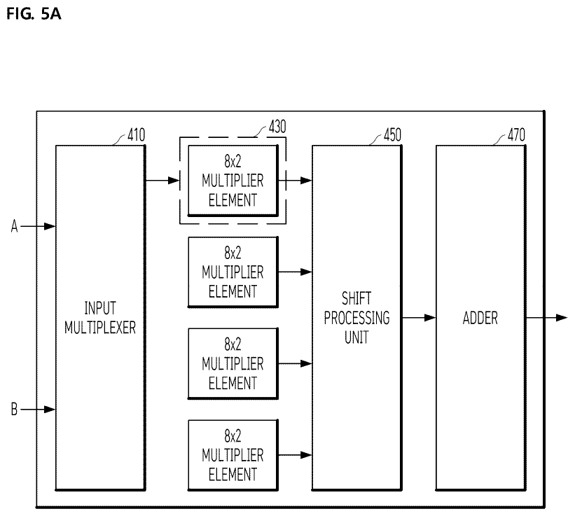

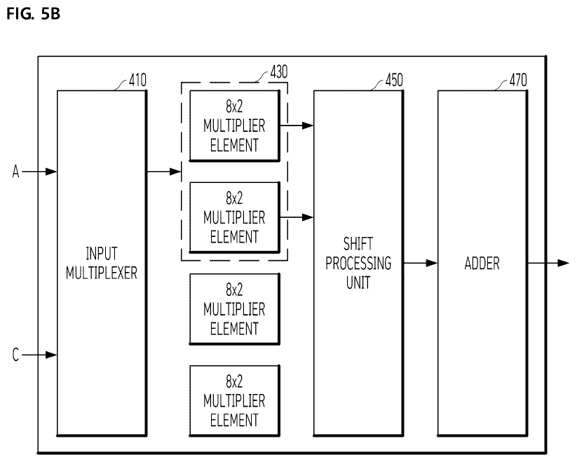

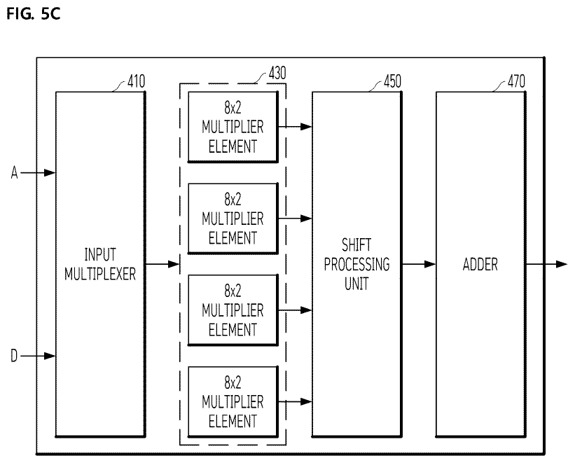

FIG. 5A is a conceptual diagram illustrating the operation of the multiplier 221 according to one embodiment of the present invention. In FIG. 5A, it is assumed that an 8-bit operand A and a 2-bit operand B are input.

When an 8-bit operand A and a 2-bit operand B are input, the input multiplexer 410 may provide the operand to one 8×2 multiplier element. The 8×2 multiplier element may perform multiplication based on the information provided. That is, four 8×2 multiplier elements may operate independently to process multiplication for different inputs simultaneously.

FIG. 5B is a conceptual diagram illustrating the operation of the multiplier 221 according to one embodiment of the present invention. In FIG. 5B, it is assumed that an 8-bit operand A and a 4-bit operand C are input.

When an 8-bit operand A and a 4-bit operand C are input, the input multiplexer 410 may provide the operand to two 8×2 multiplier elements. That is, two 8×2 multiplier elements may be paired to perform multiplication. For example, the first multiplier element may perform the multiplication between the operand A and the lower 2 bits of the operand C, and the second multiplier element may perform the multiplication between the operand A and the upper 2 bits of the operand C. The first multiplier element and the second multiplier element may individually provide the result of the partial product to the shift processing unit 450. The shift processing unit 450 may shift the partial product of the second multiplier element by 2 bits. The shift processing unit 450 may provide the shift result to the adder 470. The adder 470 may add the partial product of the first multiplier element and the partial product of the shifted second multiplier element and output the added final result value.

FIG. 5C is a conceptual diagram illustrating the operation of the multiplier 221 according to one embodiment of the present invention. In FIG. 5C, it is assumed that an 8-bit operand A and an 8-bit operand D are input.

When an 8-bit operand A and an 8-bit operand D are input, the input multiplexer 410 may provide the operand to four 8×2 multiplier elements. That is, four 8×2 multiplier elements may be paired to perform multiplication. For example, the first to fourth multiplier elements may perform multiplication on the operand A and the operand D divided into 2-bit parts. The first to fourth multiplier elements may each individually provide the result of the partial product to the shift processing unit 450. The shift processing unit 450 may shift the partial product of the first multiplier element by 0 bits, the partial product of the second multiplier element by 2 bits, the partial product of the third multiplier element by 4 bits, and the partial product of the fourth multiplier element by 6 bits. The shift processing unit 450 may provide the shift result to the adder 470. The adder 470 may add the partial products of the shifted first to fourth multiplier elements and output the added final result value.

In this way, according to one embodiment of the present invention, the processor 150, particularly the multiplication unit 220, may improve the throughput by reconfiguring the internal lower multiplier, adder, and shifter as the degree of quantization increases. In addition, the processor 150 may always output in a 16-bit floating-point format by converting the number of shifts determined by the FSM according to the precision.

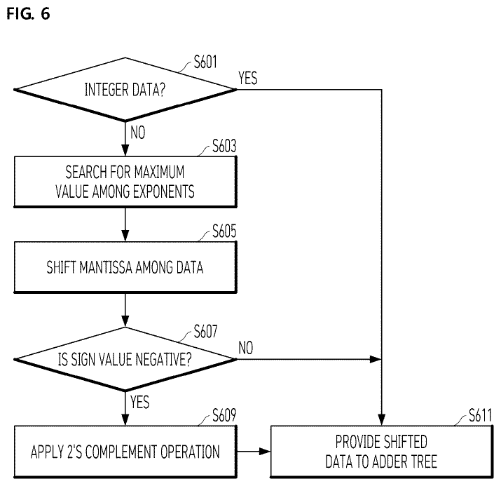

In addition, the multiplication unit 220 may reconfigure and use a high-speed processor such as a Wallace tree for intermediate partial sum processing according to each mixed-precision case. The multiplication unit 220 may achieve an increase in throughput due to system reconfiguration in low precision by outputting when each operation step according to the input precision is completed, including bypass, and may perform a MAC operation by combining with a lower adder tree as illustrated in FIG. 6B.

For example, mixed-precision MAC operations may be performed on BF16 activation values and weight values of INT2, INT4, and INT8, respectively, and the memory reduction and throughput increase for quantization are proportional.

When the multiplication is completed through FIGS. 3A to 3D, the processor 150 may proceed with the preprocessing process.

FIG. 6 is a flowchart illustrating an operating method of the processor according to one embodiment of the present invention. In particular, FIG. 6 is a flowchart illustrating the operation process of the preprocessing unit 230.

In Step S601, the preprocessing unit 230 may determine whether the data stored in the operand collector 210 is integer data that has passed through the multiplication unit 220 by utilizing a 1-bit weight and integer activation. When the data is integer data (‘Yes’ in Step S601), in Step S611, the preprocessing unit 230 may bypass the data to the adder tree 240 without performing any separate preprocessing on the integer data.

Meanwhile, when the data is not integer data (‘No’ in Step S401), in Step S603, the preprocessing unit 230 may divide the input floating-point data into the sign section, the exponent section, and the mantissa section, and search for the data having the maximum value among the plurality of input exponent sections.

In Step S605, the preprocessing unit 230 may obtain the difference between the maximum exponent section searched in Step S403 and the remaining exponents and shift the mantissa section of the input floating-point data by the corresponding difference.

In Step S607, the preprocessing unit 230 may determine whether the sign value of the input floating point data is negative. When the sign value is not negative (‘No’ in Step S607), in Step S611, the preprocessing unit 230 may provide the shifted data in Step S605 to the adder tree 240. Meanwhile, when the sign value is negative (‘Yes’ in Step S607), in Step S609, the preprocessing unit 230 may apply a 2's complement operation to the data shifted in Step S605.

The preprocessing unit 230 may provide data to which the 2's complement operation has been applied to the adder tree 240 in Step S609.

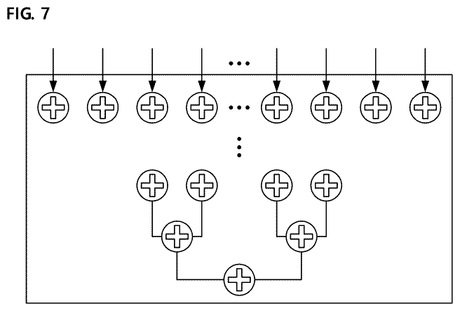

FIG. 7 is a conceptual diagram illustrating the operation of the processor according to one embodiment of the present invention. In particular, FIG. 7 is a conceptual diagram illustrating the operation of the adder tree 240.

The adder tree 240 may be configured as a parallel operation structure that continuously performs addition by grouping data items in pairs when data is output from the operand collector 210, the multiplication unit 220, and the preprocessing unit 230. For example, the adder tree 240 may be configured as a parallel operation structure that continuously adds by grouping data items in pairs when 64 data items are output from the operand collector 210, the multiplication unit 220, and the preprocessing unit 230.

According to one embodiment of the present invention, when a quantization method with a weight of 2 bits or more is followed, the adder tree 240 may perform 16-bit-16-bit addition.

According to one embodiment of the present invention, when the weight is 1 bit and the activation is 8 bits, the adder tree 240 may divide the 16-bit-16-bit adder into two 8-bit adders each and perform the operation in an 8-bit-8-bit-8-bit-8 bit addition method.

According to various embodiments of the present invention, the adder tree 240 may divide the 16-bit-16-bit adder into 4-bit adders.

The conventional IEEE single fused multiply add format may only support addition for two floating-point numbers. In contrast, the combination unit of the adder tree 240 and the multiplication unit according to the embodiment of the present invention may perform operations in a fused format for a plurality of mixed-precisions at once, thereby maintaining high accuracy with less normalization and rounding, and may achieve increased throughput while directly supporting mixed-precision operations by precisely reconstructing the basic operation units (adder, shifter, multiplier). Ultimately, it enables more effective and precise operations while maintaining the IEEE format for the result data.

According to one embodiment of the present invention, the adder tree 240 may perform an operation to find the maximum value of an exponent among input data, and then perform bit alignment shifting based on the difference (the result of a subtraction operation) between the maximum value of the exponent and the input data. The adder tree 240 may perform addition at once by using a mantissa tree, and then perform normalization and rounding operations by using a leading zero detector (LZD) or a leading zero anticipator (LZAD).

The adder tree 240 according to one embodiment of the present invention may perform normalization and rounding operations only at the end, unlike the conventional method of cutting each tree into two and performing normalization and rounding operations on each tree layer, and may process major parts of the entire floating-point operation in parallel at once, thereby improving the throughput per hardware area and the precision and processing speed of the floating-point operation.

A mixed precision processing device according to an embodiment of the present invention is a device configured in various forms, such as a tree-based or systolic array-based processing unit, and capable of performing matrix-vector and matrix-matrix operations, and includes an accessory device capable of processing activation functions and special operations such as Masking, ReduceMax, Concat, Reshape, Unsqueeze, Gather, Transpose, Residual, Swiglu, and Gelu, and additionally has a Sin and Cos operator (including a lookup table) to support trigonometric function-based operations such as ROPE and Position Embedding. In particular, it is possible to simultaneously process high precision of 1 bit and more, and 1-bit precision may be processed by a simple addition operation, and 2-bit or more may be processed by a MAC operation combining multiplication and addition. Through this, addition and MAC operations of various precisions such as floating point and integer operations may be efficiently performed in one architecture.

According to one embodiment of the present invention, in order to stably supply data of various precisions, a pre-load or streaming load memory system such as a FIFO or queue, ping-pong buffer is provided, which may store data of various precisions in a single unit. In addition, by considering the memory bandwidth and the processing capacity of the processing unit, the dimension (unit processing capacity) and lane (the number of parallel processing) of the entire processor and the precision-aware tiling algorithm are adjusted to perform an optimized matrix operation, and a vector register for data reuse, a main memory (HBM, LPDDR, DDR), bias and scale, and a general register for storing other activation data are included. A transpose unit may be inserted according to the memory and operation characteristics. Specifically, for MHA, GQA, or MQA, the tiling algorithm including pre-load and streaming or the dimension and lane of the entire processor may be determined according to the head dimension and the input sequence length or AI model layer structure including FFN, and by applying this, waste of processing capacity due to the difference in memory bandwidth is prevented in a situation where weights and key-values are quantized with different precisions. For example, in a situation where the activation is 16 bits, the weights are quantized to 16 bits, and KV is quantized to INT 4 bits, the pre-load and tiling algorithms are applied considering the increase in each computational amount and the increase in memory bandwidth due to quantization, so that computing may be utilized to the maximum extent. Here, by adjusting the size fetched according to the processing capacity of the current computing unit, the computing unit may always be utilized efficiently. In particular, HBM channels can be distributed and used according to the system.

In addition, the processor may be used by determining the internal structure combination according to the desired precision combination, such as FP32, FP16, BF16, FP8, FP4, INT8, INT4, INT2, INT1, or the like, in addition to the examples described above.

In addition, since the processor may support various mixed-precisions, outlier aware quantization, which is generally used to maintain quantization precision, may be used more actively than in conventional fixed-precision processor systems. This may be used in combination with a sparse format-dedicated encoder-decoder unit.

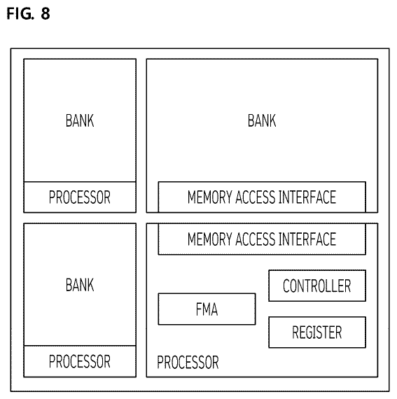

FIG. 8 is block diagrams schematically illustrating the mixed-precision processing system according to one embodiment of the present invention.

The processor according to one embodiment of the present invention may also be applied to architectures such as processing in memory (PIM) and processing near memory (PNM), as in illustrated FIG. 8.

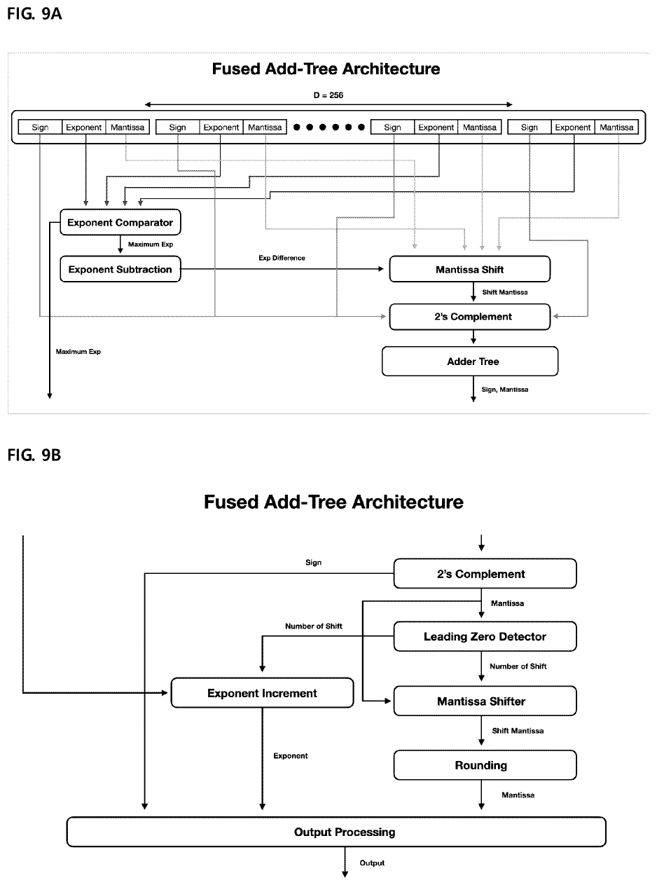

FIG. 9A and FIG. 9B are flowcharts illustrating the operating method of the reconfigurable mixed-precision processing system according to one embodiment of the present invention; and

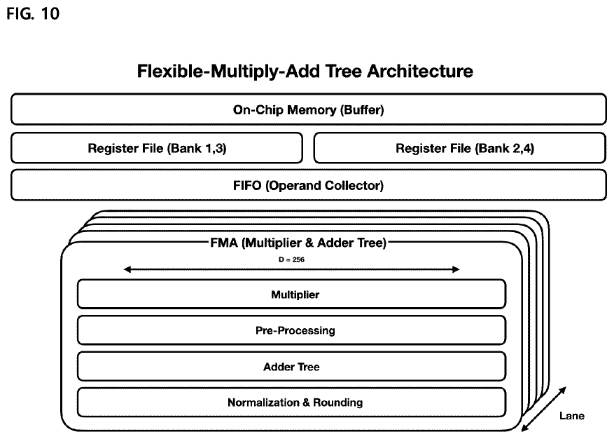

FIG. 10 is a block diagram schematically illustrating the reconfigurable mixed-precision processing system according to one embodiment of the present invention.

Meanwhile, various embodiments described in the present specification may be implemented by hardware, middleware, microcode, software, and/or a combination thereof. For example, various embodiments may be implemented in one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof.

Also, for example, various embodiments may be embodied or encoded in a computer-readable medium containing commands. The commands embodied or encoded in the computer-readable medium may cause a programmable processor or other processor to perform a method when the commands are executed, for example. The computer-readable medium includes a computer storage medium, and the computer storage medium may be any available medium that can be accessed by a computer. For example, such a computer-readable medium may include a RAM, a ROM, an EEPROM, a CD-ROM or other optical disk storage medium, a magnetic disk storage medium, or other magnetic storage devices.

Such hardware, software, firmware, or the like may be implemented within the same device or within separate devices to support the various operations and functions described herein. Additionally, components, units, modules, components, or the like described as “˜units” in the present invention may be implemented together or individually as separate but interoperable logic devices. The depiction of different features for modules, units, or the like is intended to emphasize different functional embodiments and does not necessarily imply that they must be realized by separate hardware or software components. Rather, the functionality associated with one or more modules or units may be performed by separate hardware or software components, or integrated into common or separate hardware or software components.

Although the operations are depicted in the drawings in a particular order, it should not be understood that these operations need to be performed in the particular order depicted, or in any sequential order, or that all of the depicted operations need to be performed to achieve a desired result. In some circumstances, multitasking and parallel processing may be advantageous. Furthermore, the separation of the various components in the embodiments described above should not be understood to require such separation in all embodiments, and it should be understood that the components depicted may generally be integrated together in a single software product or packaged into multiple software products.

The electronic device, server, or external device according to the various embodiments of the present document described above may include, for example, at least one of a smartphone, a tablet PC, a mobile phone, a video phone, a desktop PC, a laptop PC, a personal digital assistant (PDA), a portable multimedia player (PMP), an MP3 player, a mobile medical device, a camera, or a wearable device.

According to various embodiments, a wearable device may include at least one of an accessory type (for example, a watch, a ring, a bracelet, an anklet, a necklace, glasses, contact lenses, or a head-mounted device (HMD)), an integrated type of fabric or clothing (for example, an electronic garment), a body-attached type (for example, a skin pad or tattoo), or a bio-implantable type (for example, an implantable circuit).

In some embodiments, the electronic device or external device may be a home appliance. The home appliance may include, for example, at least one of a television, a digital video disk player (DVD player), an audio, a refrigerator, an air conditioner, a vacuum cleaner, an oven, a microwave oven, a washing machine, an air purifier, a set-top box, a home automation control panel, a security control panel, a TV box, a game console, an electronic dictionary, an electronic key, a camcorder, or an electronic picture frame.

In another embodiment, the electronic device, the external device, or the wearable device may include at least one of various medical devices (for example, various portable medical measuring devices (such as a blood sugar meter, a heart rate meter, a blood pressure meter, or a thermometer), magnetic resonance angiography (MRA), magnetic resonance imaging (MRI), computed tomography (CT), a camera, or an ultrasound machine), a navigation device, a global navigation satellite system (GNSS) , an event data recorder (EDR), a flight data recorder (FDR), an automobile infotainment device, a home robot, or an internet of things device (for example, a light bulb, various sensors, an electric or gas meter, a sprinkler device, a fire alarm, a thermostat, a streetlight, an exercise machine, a hot water tank, a heater, a boiler, or the like).

As described above, the best embodiment has been disclosed in the drawings and the specification. Although specific terms have been used herein, they have been used only for the purpose of describing the present invention and have not been used to limit the meaning or the scope of the present invention described in the claims. Therefore, those skilled in the art will understand that various modifications and equivalent other embodiments are possible from this. Therefore, the true technical protection scope of the present invention should be determined by the technical idea of the appended claims.

What is claimed is:

1. An operating method of a reconfigurable mixed-precision processing apparatus, the operating method comprising:
performing a multiplication on a plurality of operands to calculate a first result value in a floating-point format;
performing preprocessing on the first result value to calculate a second result value;
performing an addition on a mantissa value of the second result value to calculate a third result value; and
converting a mantissa of the third result value into a mantissa in the floating-point format to calculate a fourth result value,
wherein the operand includes any one of the floating-point format, an integer format, and 1 bit.

2. The operating method of claim 1, wherein the calculating of the first result value includes,
in a case of multiplication of data of the floating-point format—floating-point data and data of the integer format—integer data,
calculating a sign using an XOR gate for a sign of the floating-point data and a sign of the integer data,
calculating a multiplication value by multiplying the mantissa value of the floating-point data and an integer value of the integer data,
performing a shift according to a preset criterion from a least significant bit of the multiplication value,
increasing an exponent value of the floating-point data by the number of times the shift is performed, and
performing rounding in a preset method based on the shift result to calculate the first result value.

3. The operating method of claim 1, wherein the calculating of the first result value includes,
in a case of multiplication of first integer data and second integer data,
calculating a sign using an XOR gate for a sign of the first integer data and a sign of the second integer data,
calculating a multiplication value by multiplying an integer value of the first integer data and an integer value of the second integer data,
calculating an absolute value of the multiplication value,
calculating the number of leading ‘0’s in binary representation of the calculated absolute value,
calculating an exponent according to a preset expression based on the number of ‘0’s and a bias,
calculating an upper N bit of the multiplication value as the mantissa according to target output precision, and
calculating the first result value using the sign, the exponent, and the mantissa.

4. The operating method of claim 1, wherein the calculating of the second result value includes
checking whether the data is integer data that has passed through a multiplication unit by using a 1-bit weight and integer activation,
dividing, when the data is not the integer data, a plurality of floating-point data into a sign section, an exponent section, and a mantissa section, and searching for data having a maximum value among the plurality of exponent sections,
obtaining a difference between a maximum exponent value of the searched data and exponent values of the other data and shifting the mantissa value of the floating-point data by the difference,
determining whether a sign value of the floating-point data is negative, and
performing a 2's complement operation on the shifted data when the sign value is negative.

5. The operating method of claim 1, wherein the calculating of the first result value includes,
in a case of multiplication of first floating-point data and second floating-point data,
calculating a sign using an XOR gate for a sign of the first floating-point data and a sign of the second floating-point data,
calculating a multiplication value by multiplying an mantissa value of the first floating-point data and an mantissa value of the second floating-point data,
calculating a addition value by adding an exponent value of the first floating-point data and an exponent value of the second floating-point data,
calculating a first normalization value by normalizing the addition value to be less than or equal to a preset value,
calculating a second normalization value by normalizing the multiplication value to be less than or equal to a preset value,
calculating the first result value through performing rounding for the calculated sign, the first normalization value, the second normalization value.

6. A mixed-precision processing apparatus, comprising:
a multiplication unit configured to perform a multiplication on a plurality of operands to calculate a first result value in a floating-point format;
a preprocessing unit configured to perform preprocessing on the first result value to calculate a second result value;
an adder tree configured to perform an addition on a mantissa value of the second result value to calculate a third result value; and
a normalization unit and a rounding unit configured to convert a mantissa of the third result value into a mantissa in the floating-point format to calculate a fourth result value,
wherein the operand includes any one of the floating-point format, an integer format, and 1 bit.
